(19) United States
(12) Patent Application Publication
(10) Pub. No.: US 2014/0304227 A1
(43) Pub. Date: Oct. 9, 2014

(54) Systems, Computer Program Products, and Methods Using Data Set Objects

(71) Applicant: Jorge Taylor, Burlingame, CA (US)

(72) Inventor: Jorge Taylor, Burlingame, CA (US)

(73) Assignee: Adobe Systems Incorporated, San Jose, CA (US)

(21) Appl. No.: 12/048,619

(22) Filed: Mar. 14, 2008

(51) Int. Cl. G06F 17/30

(52) U.S. Cl. 707/626; 707/E17.005; 707/661

(57) ABSTRACT

A system comprises a first component creating an Hypertext Markup Language (HTML) data set storage object, a second component identifying data to be extracted from a first HTML document by the data set storage object, and a third component inserting the data set storage object into a second HTML document and structuring the second HTML document so that the extracted data is arranged when the second HTML document is rendered.

### BACKGROUND

Various systems exist today that allow a user to extract data from a document in one or more markup languages. One example is the Web Query feature that is sometimes included in the Microsoft EXCEL™ spreadsheet. Web Query allows a user to pull data from a World Wide Web (web) page into a spreadsheet. Web Query does have some limitations. For instance, it only supports pulling data from Hypertext Markup Language (HTML) tables, as opposed to more arbitrary container structures. Further, Web Query performs a one-step operation to extract the data from an HTML table in a web page and import that data into a spreadsheet. From a user's standpoint (e.g., an end user writing a macro-program), no other options exist, as there is no way to exploit any kind of storage between the source HTML and the spreadsheet.

Another example is systems that use Extensible Stylesheet Language (OSL) and/or Extensible Stylesheet Language Transformation (XSLT). Essentially, XSL allows a user to extract data from well-formed HTML. But like Web Query, it tends to be a one-step operation to pull content from HTML and transform it into another view. Thus, there is no storage or other functionality between the source HTML and the next view. Additionally, XSL is very complicated, and while it is possible to perform transforms from HTML to extract data from one HTML page and generate another HTML page, for the majority of design-oriented users and casual or hobby users, it can be very difficult to use XSL.

Another example includes systems that use the SPRY™ utility (available from Adobe Systems Incorporated). The SPRY™ utility creates a data storage object within a web application. The data storage object is able, when instantiated, to extract data from XML and/or a database and insert that content into the web application. In effect, the SPRY™ utility assists users to include Asynchronous JavaScript and XML (AJAX) functionality in web applications. Users may employ one or more interfaces to choose a format for the data to take when it is inserted into the web application. However, as mentioned above, design-oriented professionals often lack the skills necessary to access data from XML and databases (or to store data therein). Thus, even easy-to-use tools, such as the SPRY™ utility, can often be beyond the skill sets of designers.

### BRIEF SUMMARY

Various embodiments of the present invention are directed to systems, methods, and computer program products that provide a way to create data storage objects that extract data from an HTML source document and display the data in a web application. Some embodiments allow a user to use regular HTML pages as data sources the way that developers currently use databases as data sources. These HTML data set objects can extract HTML data and use it in various and arbitrary views in a web application.

Various embodiments include Application Development Environments (ADEs) that allow a user to create or choose a source HTML page, create an HTML data set object, and create one or more web applications that include the HTML data set object. Such embodiments may allow a user who is familiar with HTML to leverage that familiarity when creating more interactive, rich web applications without having to invest the resources to learn the use of databases.

Additionally, various embodiments include web applications with HTML data set objects therein. Thus, in some embodiments, a web application includes HTML data set objects that extract data from a source HTML document and arrange the data in a format specified by the web application.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of an exemplary system adapted according to one embodiment;

FIG. 2 is an illustration of an exemplary HTML document that includes content that is extracted according to one embodiment;

FIG. 3 is an illustration of exemplary dialog boxes adapted according to one embodiment;

FIG. 4 is an illustration of an exemplary dialog box adapted according to one embodiment;

FIG. 5 is an illustration of the dialog box of FIG. 4 after a user has selected an arrow;

FIG. 6 is an illustration of an exemplary dialog adapted according to one embodiment;

FIG. 7 is an illustration of an exemplary dialog adapted according to one embodiment;

FIG. 8 is an illustration of a pane of an exemplary ADE adapted according to one embodiment;

FIG. 9 is an illustration of an exemplary resulting web document adapted according to one embodiment;

FIG. 10 shows exemplary views of an HTML source document in a rendered view and a code view;

FIG. 11 is an illustration of an exemplary method adapted according to one embodiment; and

FIG. 12 illustrates an exemplary computer system adapted according to one embodiment.

### DETAILED DESCRIPTION

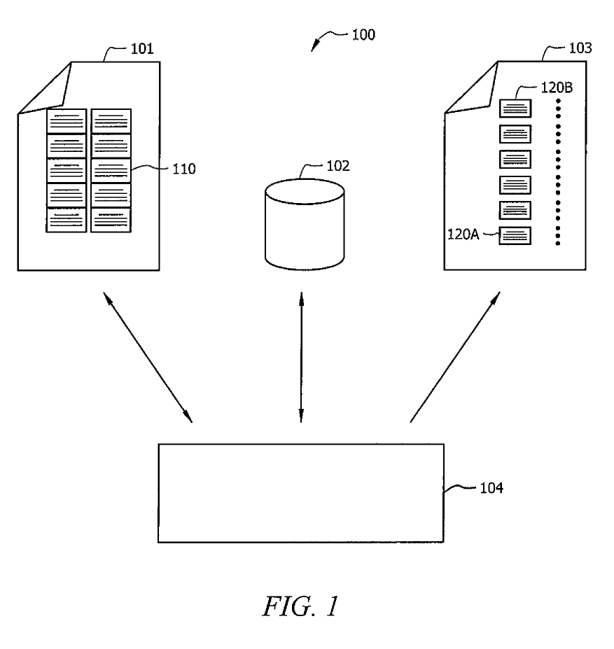

FIG. 1 is an illustration of exemplary system 100 adapted according to one embodiment. Document 101 is a World-Wide-Web (“web”) document that includes Hypertext Markup Language (HTML) tags and underlying content. When rendered by, e.g., a web browser, the HTML markup arranges the underlying content into a first container 110, which in this example, is a table. Document 101 can be referred to as an HTML document because it uses HTML to arrange underlying content. However, it should be noted that HTML documents often contain other programming/design features, such as script (e.g., JAVASCRIPT™), Cascading Style Sheets (CSS) data, and the like. Further, it should be noted that the terms “content” and “data” are used in this description interchangeably with respect to HTML and refer to the information in a web page.

Tool 104 identifies content to be extracted from document 101. Tool 104 can be any kind of hardware- or software-based utility providing the functionality discussed herein. An example of a suitable utility for use as tool 104 includes a processor-based device running an Application Development Environment (ADE), such as DREAMWEAVER™, available from Adobe Systems Incorporated.

An example technique for extracting content from a document (e.g., document 101) includes placing identifying semantics into the document. For instance, within the HTML markup, a user or a program places “table 1” or other text to identify one or more tables. A selector tool (not shown) can then be used to parse the HTML document to search for all tables labeled “table 1.” Action can then be performed on the content within the identified tables or on the tables themselves. In this particular example, a selector provided by tool 104 can be used to parse document 101 and to extract content from tables with a given semantic identifier.

Tool 104 also creates intermediate data set 102. Content can include any of a variety of hyperlinks, pictures, text, and the like. An example of an appropriate intermediate data set is an object-based data set, that when instantiated by an executing program, performs the extraction that was described above. The object then “holds” the data, which can be used by one or more other web applications. The functionality available in the SPRY™ software tool is operable to create a JAVASCRIPT™-based object in one or more other web applications that can be used as intermediate data sets.

Tool 104 also creates new web application 103 that includes one or more web pages. Web application 103 also includes HTML markup therein that, when application 103 is rendered by a browser, arranges the content into container objects 120₁ to 120ₙ. In this example, tool 104 inputs code into web application 103, so that when application 103 is rendered, an object corresponding to data set 102 is instantiated. The object extracts content from document 103 and arranges the content into containers 120 of web application 103.

Thus, the embodiment shown in FIG. 1 allows a web designer (or developer) to extract content from one HTML arrangement and insert it into a second HTML arrangement. It should also be noted that, during runtime, tool 104 is generally not present. Instead, documents 101 and 103 are deployed to one or more web servers. When an end user views document 103 on a web browser, the script within document 103 is executed, and data storage objects are instantiated, thereby allowing the end user's browser to request and display extracted data.

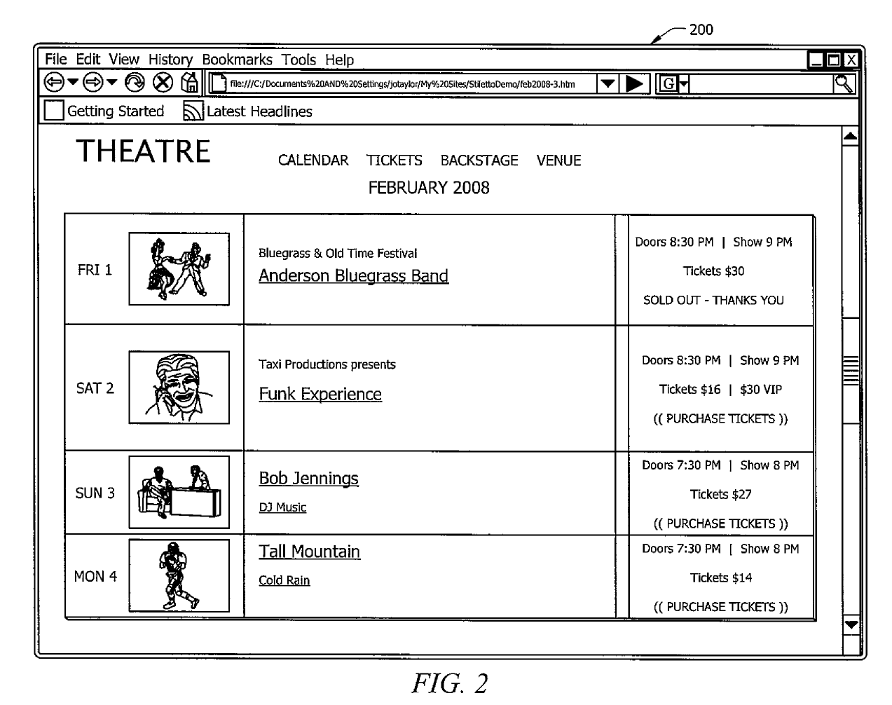

FIGS. 2-10 illustrate various embodiments of the invention that include an example wizard, used during design time, to assist a designer in creating web applications and data storage sets. FIGS. 2-10 are described below in a logical order according to one embodiment.

FIG. 2 is an illustration of example HTML document 200 that includes content that is extracted according to one embodiment. The web page shown in FIG. 2 is illustrated as it would be rendered on a user's browser screen. As can be seen, document 200 includes, among other things, content arranged in a two-dimensional chart, showing dates, names of musical acts, and details about tickets. In the following discussion, document 200 is used as a source HTML document.

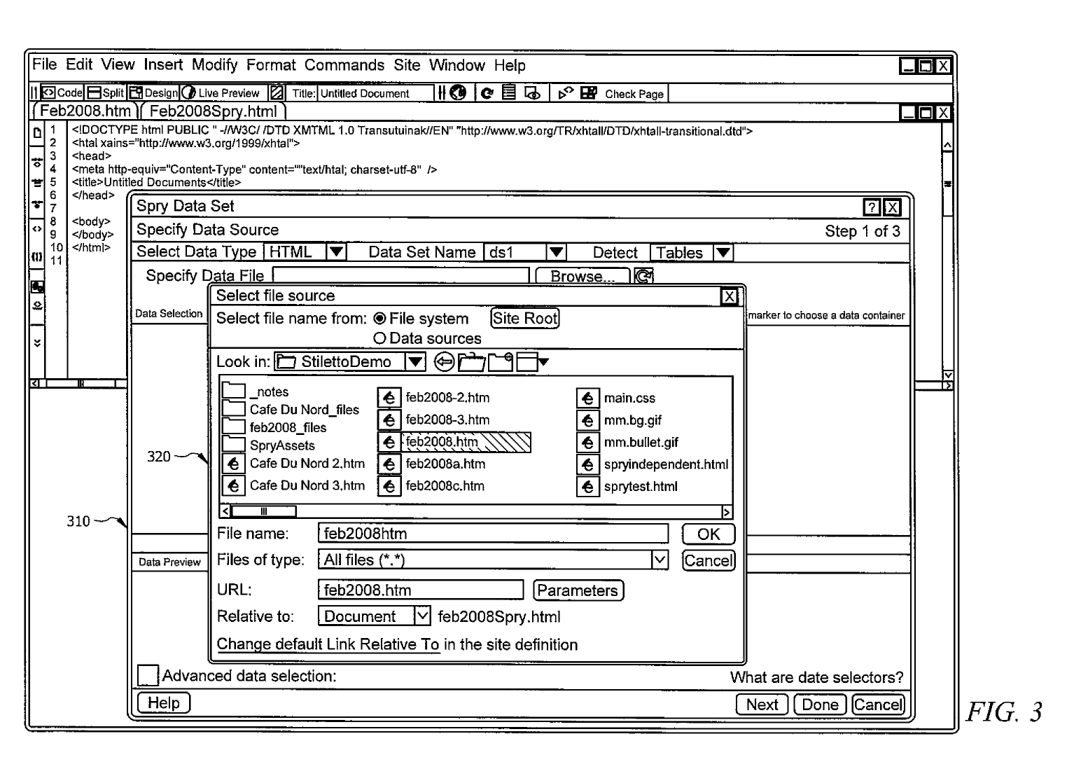

FIG. 3 is an illustration of exemplary dialog boxes 310 and 320 adapted according to one embodiment. Dialog box 310 allows a user to enter a data source. Dialog box 320 is a file explorer box that allows a user to pick a file to enter into dialog box 310. Using dialog boxes 310 and 320, the user, in this example, specifies web page 200 as the source for content arranged by HTML.

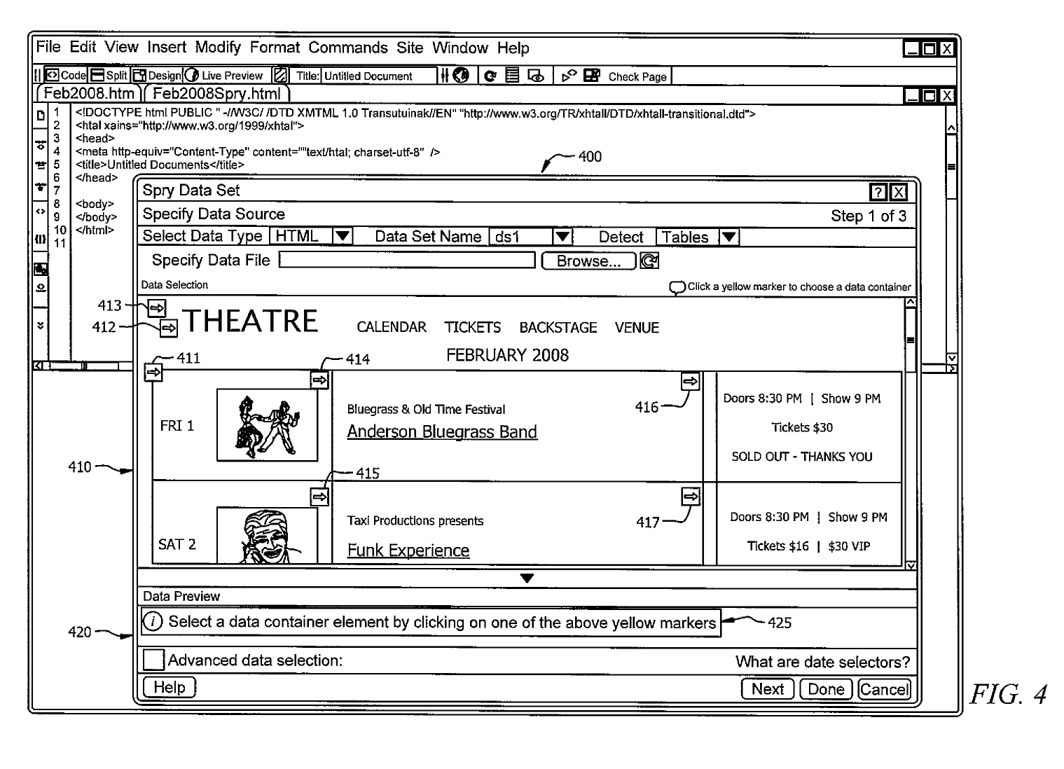

FIG. 4 is an illustration of exemplary dialog box 400 adapted according to one embodiment. Dialog 400 includes embedded browser 410 and data preview pane 420. Embedded browser 410 shows a rendered view of the source document, whereas data preview pane shows a text version of the source document. Prompt 425 encourages a user to use embedded browser 410 to choose a container element from source web page 200, from which to extract content. In this embodiment, a tool, such as tool 104 (FIG. 1) parses web page 200 to identify container elements therein. In dialog 400, the containers are indicated to the user through arrows 411-417. A user can then select a desired container by selecting an arrow 411-417. In some embodiments, identifying semantics are already present in the source HTML document when the document is parsed. If not, then dialog 400 may prompt the user to open the source file and insert identifying semantics therein. However, well-formed HTML often includes identifying semantics for other purposes (e.g., use of CSS), and those identifiers can be used by tool 104.

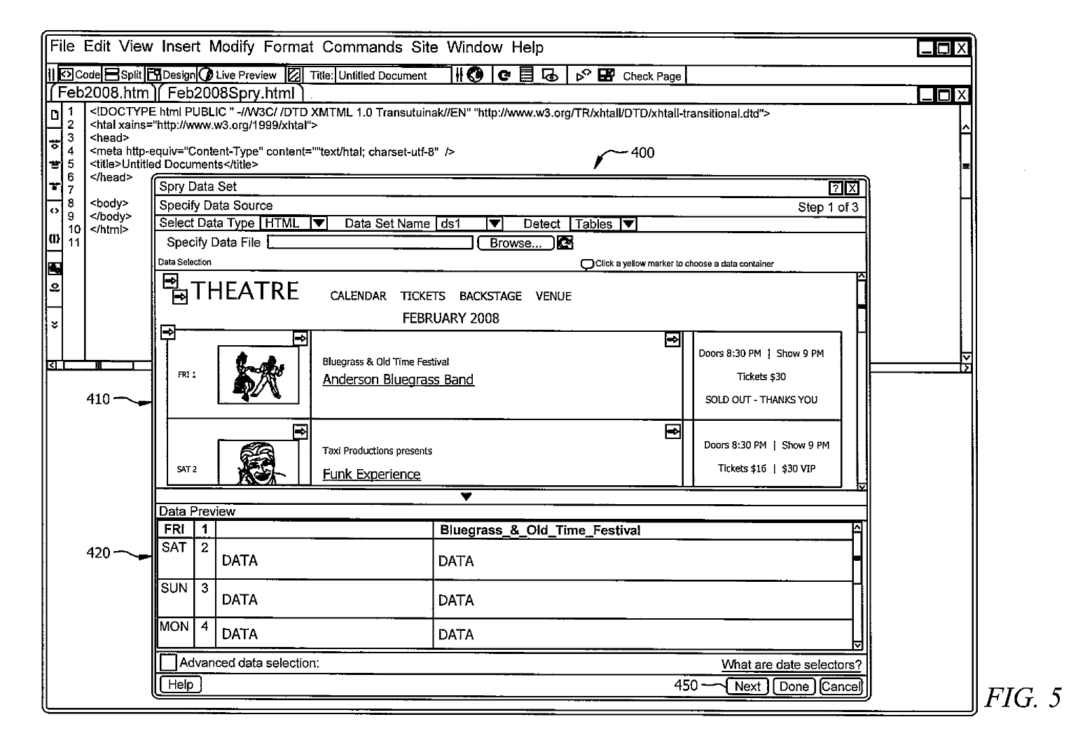

FIG. 5 is an illustration of dialog box 400 after a user has selected arrow 411. After selection of a container, data preview pane 420 presents the content from the container in text format. The content, itself is not shown in FIG. 5, as it is replaced with the term “data” for simplicity of illustration. It is understood, though, that in various embodiments of the invention the content in pane 420 is displayed for the user, and it includes, among other things, words, locators for pictures, and the like, as well as markup indicating attributes, such as font size, margins, font color, etc. When the user selects NEXT button 450, the tool progresses to dialog box 600.

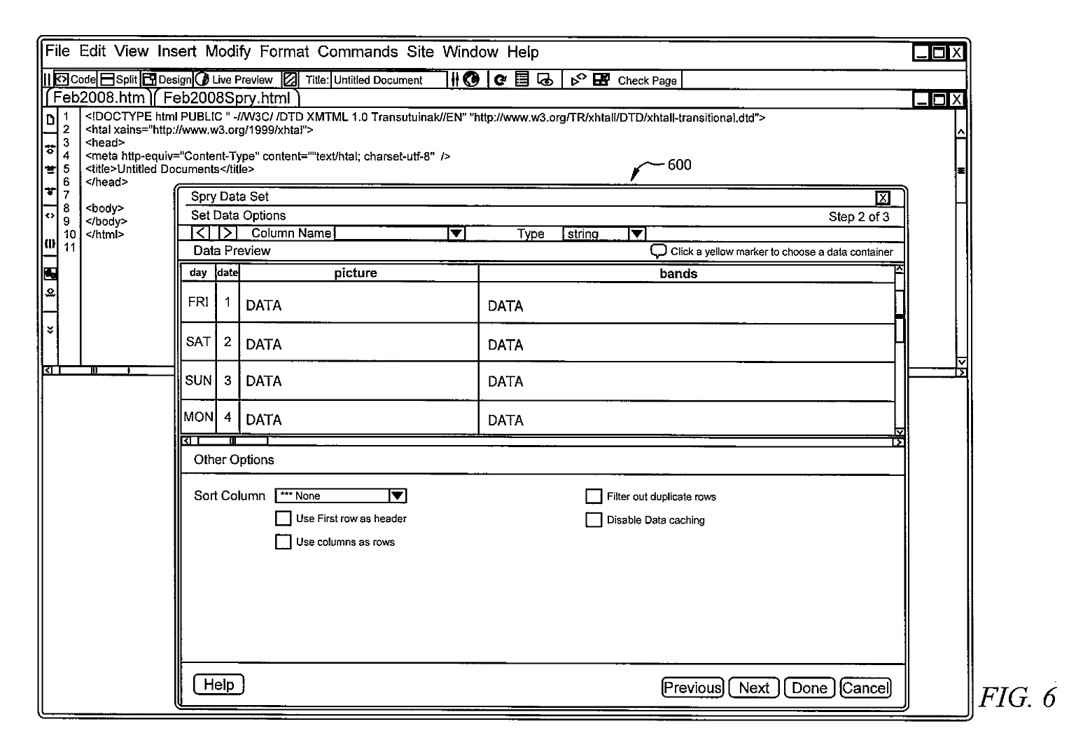

FIG. 6 is an illustration of exemplary dialog box 600 adapted according to one embodiment. Dialog box 600 allows the user to change the name and type of the data set columns and configure other data set options.

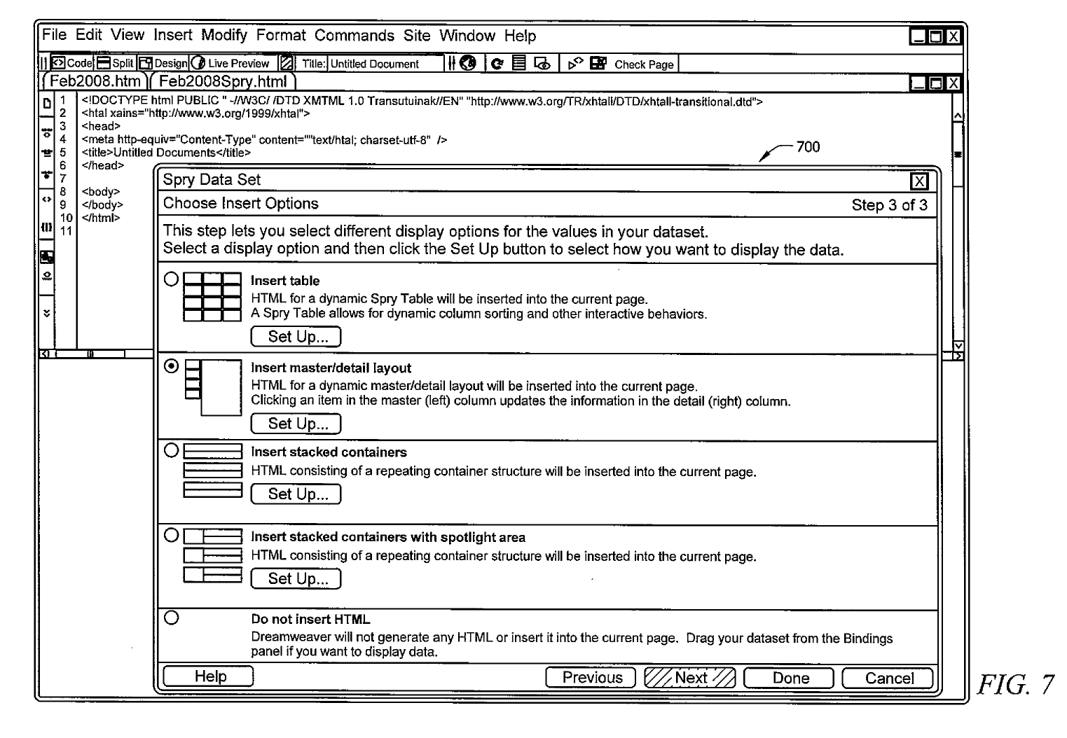

FIG. 7 is an illustration of exemplary dialog box 700 adapted according to one embodiment. Dialog box 700 allows a user to choose a display layout for the content to take when it is inserted into another web application. Alternatively, dialog box 700 also allows a user to skip generating layout code. In the example shown in FIG. 7, the user has chosen one of several layout options, specifically, the “Master/Detail” layout. This selection commands the tool to insert HTML markup interleaved with references to an intermediate data set object as well as other behavior. The references and behavior can be inserted as script (e.g., JAVASCRIPT™) into a web document. Some ADEs (including DREAMWEAVER™) can generate script automatically based on user input and insert that script into a web application that is being written. Further, web browsers generally contain tools that allow them to execute script, so that an end-user's browser will receive a web document and render the application with its full set of behaviors.

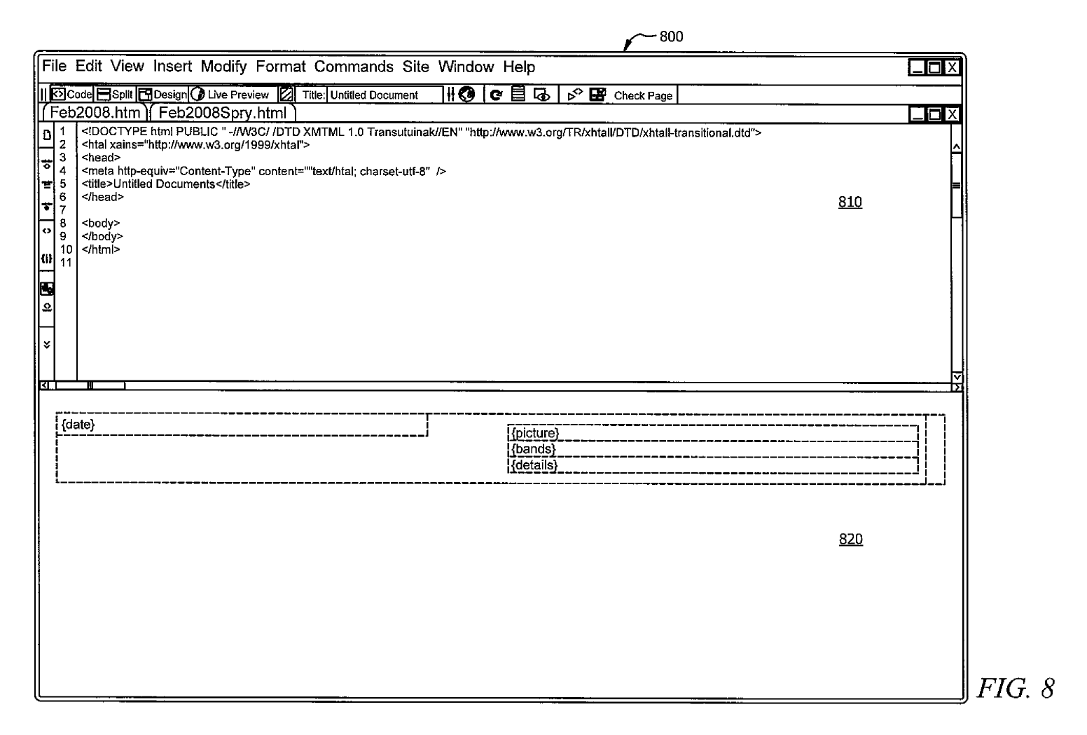

FIG. 8 is an illustration of pane 800 of an exemplary ADE adapted according to one embodiment. Pane 800 includes code view 810, which shows an editable view of HTML markup, CSS data, script, and the like for a user. A user can then manipulate the code and data that was generated after the interactions shown in FIG. 7. Specifically, the user can view and edit: 1) an intermediate HTML data set object that loads data from the selected container in the specified data source file, 2) HTML markup for master detail layout, which in this case, is a set of DIV elements with default CSS positioning, and 3) script-based instructions for mapping data from the intermediate data set into HTML markup. Pane 800 also includes browser view 820, which can provide an editable, rendered view of markup and code. However, in this example, browser view 820 is left blank for ease of illustration.

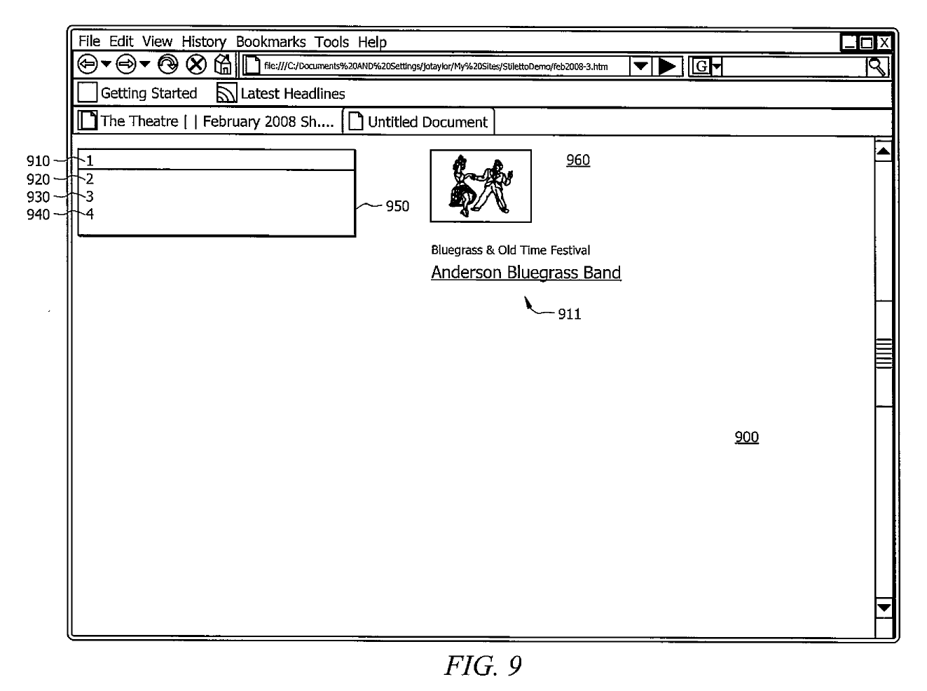

FIG. 9 is an illustration of exemplary resulting web document 900 adapted according to one embodiment. In this example, document 900 includes the inserted content from web page 200 arranged in a different manner, as specified by the code and data that is, at least partially, shown in code view 810 of FIG. 8. Further, in FIG. 9, document 900 is rendered in a browser and appears as it would to an end-user.

Selecting one of items 910, 920, 930, or 940 in master table 950 causes detail region 960 to update with detail information for the respective item 910, 920, 930, or 940. In the example of FIG. 9, the user has selected item 910, causing content 911 to appear. Specifically, selecting item 910 causes the browser to send a request to the server (not shown) for data that is held by the intermediate data set (not shown). The server sends the data, as requested, to the browser, and the data appears as content 911. The same process is performed when items 920, 930, and 940 are selected, as well.

While the example above shows data mapped from one web document into a single, other document, the scope of embodiments is not so limited. For instance, it is possible to input the same HTML markup, references, and behavior into other web applications, so that two or more web applications use the same HTML source document. Further, it is possible to create another intermediate data set from data in the source document (e.g., web page 200). Thus, two or more web applications may use the same or different source data from the same HTML source page. Moreover, in some embodiments, the source page and the destination page may be the same page, such that data is extracted from one portion of a web page and used in a different view within the same page when the page is rendered.

Further, while the example above shows use of DREAMWEAVER™ and SPRY™, the scope of embodiments is not so limited. In fact, any ADE that performs data extraction and uses intermediate data set objects can be adapted for use in some embodiments.

Additionally, while the examples above show the creation of the data set storage object as automatically performed by a “wizard,” the scope of embodiments is not so limited. In fact, any manner of creating a data set storage object, identifying portions of data to be extracted, and inserting the data set storage object can be used, including the use of manual programming steps.

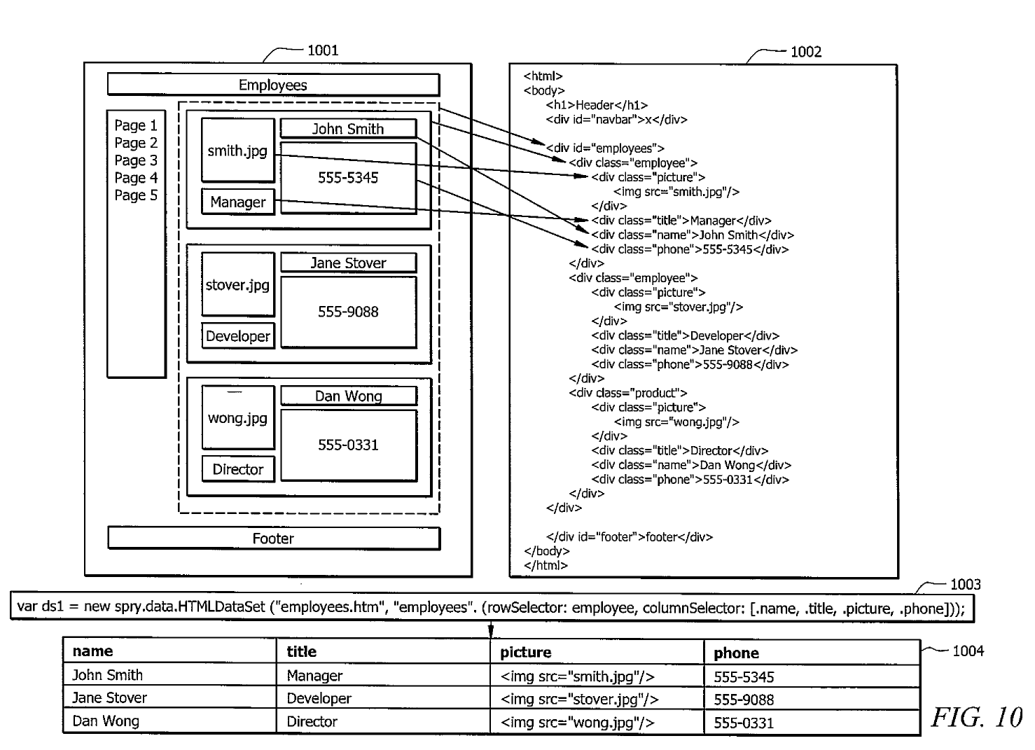

FIG. 10 shows exemplary views of an HTML source document in a rendered view 1101 and a code view 1002. Code view 1002 is a page with information laid out in repeating, stacked DIV elements. Semantics have been added to the page in the form of IDs and classes so that elements (e.g., pictures, names, numbers) can be selected using a same or similar syntax used for CSS selectors by an instantiated data set object according to one embodiment.

Exemplary line of code 1003 creates a data set object that stores data from the HTML source document by selecting identified portions. A representation of an exemplary data set object is shown as item 1004.

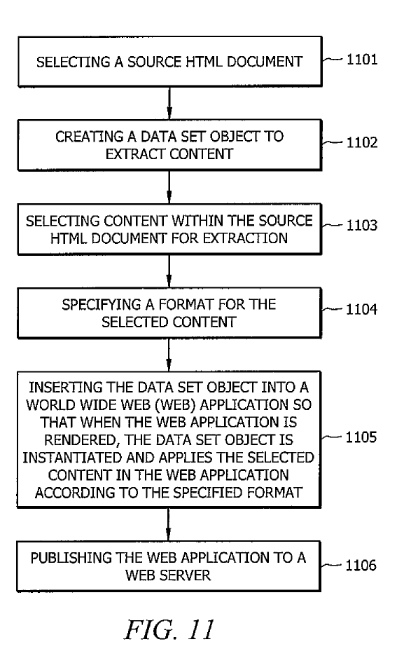

FIG. 11 is an illustration of exemplary method 1100 adapted according to one embodiment. Method 1100 may be performed, for example, by an ADE, as it creates an interactive web application. Specifically, in some embodiments, a processor-based device that executes programs of the ADE performs method 1100 as it is used to design and/or develop an interactive web page.

In step 1101, a source HTML document is selected. In some embodiments, the user chooses a document to be the source document, and the user is aided by use of an interface in the ADE. The ADE selects the document by, e.g., saving a locator for the document in memory or saving a copy of the document to a folder. If the source HTML document is not already in existence, step 1101 may further include creating the source HTML document. Further, the HTML document is not limited to including only HTML, as it is understood that some HTML document include script, CSS data, and the like in order to add desired behavior and appearance beyond that which HTML, alone, can provide.

In step 1102, a data set object is created to extract content. The data set object, in some embodiments, is a script-based object (e.g., JAVASCRIPT™, but other script-based or code-based languages can work as well) that is instantiated when one or more portions of a web application are rendered.

In step 1103, content within the source HTML document is selected for extraction. As long as the HTML is well-formed and has semantic identifiers, data can be extracted from it. Typically, identifying semantics are placed in the HTML markup within the source HTML document when the source HTML document is created. Some embodiments may include a user editing the source HTML document to edit or supplement the HTML to be better formed or to include additional semantic identifiers. Selecting content for extraction can be done automatically with a utility that receives input identifying content and then crafts code or script to programmatically extract the selected content during runtime.

In step 1104, a format is specified for the selected data. In some embodiments, step 1104 is performed by creating HTML markup that specifies one or more particular container structures for the content when it is loaded to another web application.

In step 1105, the data set object is inserted into a web application. The web application is different from the source HTML document. When the web application is rendered, the data set object is instantiated. The data set object extracts the selected content and applies the selected content in the web application according to the specified format. In many instances, the specified format is different from a format of the content in the source HTML document.

In step 1106, the web application is published to a web server. Step 1106 may also include publishing the source HTML document to the same or different web server so that data can be extracted when the web application is rendered.

Once the web application is published, a user can load the application in a browser (e.g., FIREFOX™, available from Mozilla Foundation). The browser displays (renders) content to a user and instantiates one or more data set objects. In many embodiments, the data set objects are used to provide additional content to a web page without requiring the entire web page to reload. In one example, a user selects items from a list of content on a page of the web application. As an item is selected, a data set object sends a request to one or more web servers for content. The request causes the data to be extracted from the source HTML document and sent to the data set object. The content is then rendered on a screen in the selected format. In a similar embodiment the data set object loads all of its data when the page is rendered, such that no further selection is needed to cause extraction. The data set then holds all of the extracted data and displays the data as the user interacts with various elements of the page. Such an embodiment illustrates an interesting concept of a data set object. That is, a data set object is an intermediate storage item that allows the data therein to be reused in a variety of ways. Thus, within the same page, more than one template (a block of HTML with data references) can use the data, or subsets of the data, from the data set object. An example page can have a plurality of interactive elements that appear as links, with each of the elements showing a different view of data from the same data set.

Various embodiments of the invention provide one or more advantages over prior art systems. For instance, typical prior art systems using an AJAX utility (e.g., SPRY™) could not extract data from HTML documents. Instead, such AJAX utilities focus on XML data sources and/or relational databases. However, database operation (as well as XML use) is often beyond the skill level of web designers, who typically add the design and overall feel to a web application. Web designers, though, are typically familiar with HTML containers, such as tables. Various embodiments of the present invention extend the functionality of a an AJAX utility to extract data from an HTML document. Thus, people who may not be familiar with databases but who are competent in HTML can place content in a source HTML document and create a data set object to extract data from the source HTML document.

Various embodiments also allow extracting data from a given source HTML container structure and presenting the content in one or more arbitrary HTML container structures that can be different from the source container structure. In other words, data can be extracted once and fed back to independent data arrangements within the same page. This is in contrast to XSL/XSLT, which has no intermediate storage object because each transform is separate and independent. Accordingly, embodiments of the present invention can offer more flexibility than is offered by XSL/XSLT.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like). In fact, readable media can include any medium that can store.

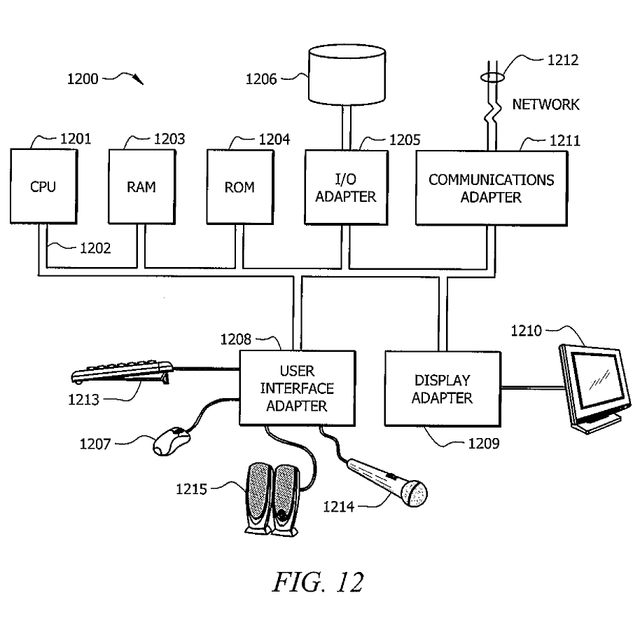

FIG. 12 illustrates an example computer system 1200 adapted according to embodiments of the present invention. That is, computer system 1200 comprises an example system on which embodiments of the present invention may be implemented (e.g., a computer executing programs of an ADE, a computer receiving a web application and/or extracted data over the Internet, a web server, etc.). Central processing unit (CPU) 1201 is coupled to system bus 1202. CPU 1201 may be any general purpose CPU. The present invention is not restricted by the architecture of CPU 1201 as long as CPU 1201 supports the inventive operations as described herein. CPU 1201 may execute the various logical instructions according to embodiments of the present invention. For example, CPU 1201 may execute machine-level instructions according to the exemplary operational flow described above in conjunction with FIG. 11.

Computer system 1200 also preferably includes random access memory (RAM) 1203, which may be SRAM, DRAM, SDRAM, or the like. Computer system 1200 preferably includes read-only memory (ROM) 1204 which may be PROM, EPROM, EEPROM, or the like. RAM 1203 and ROM 1204 hold user and system data and programs, as is well known in the art.

Computer system 1200 also preferably includes input/output (I/O) adapter 1205, communications adapter 1211, user interface adapter 1208, and display adapter 1209. I/O adapter 1205, user interface adapter 1208, and/or communications adapter 1211 may, in certain embodiments, enable a user to interact with computer system 1200 in order to input information, such as selecting a source HTML document, selecting content, interacting with a web application, and/or the like.

I/O adapter 1205 preferably connects to storage device(s) 1206, such as one or more of hard drive, compact disc (CD) drive, floppy disk drive, tape drive, etc. to computer system 1200. The storage devices may be utilized when RAM 1203 is insufficient for the memory requirements associated with storing data. Communications adapter 1211 is preferably adapted to couple computer system 1200 to network 1212 (e.g., the Internet, a WAN, MAN, LAN, etc.). User interface adapter 1208 couples user input devices, such as keyboard 1213, pointing device 1207, and microphone 1214 and/or output devices, such as speaker(s) 1215 to computer system 1200. Display adapter 1209 is driven by CPU 1201 to control the display on display device 1210 to, for example, display the user interface (such as that of FIGS. 2-10) of embodiments of the present invention.

It shall be appreciated that the present invention is not limited to the architecture of system 1200. For example, any suitable processor-based device may be utilized, including without limitation personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A system comprising:
a non-transitory computer-readable medium; and
a processor in communication with the non-transitory computer-readable medium, the processor configured to execute an application development environment, the application development environment configured to cause the processor to:
receive a first Hypertext Markup Language (HTML) file, said first HTML file comprising a container comprising content,
receive a selection of said container,
automatically create and embed program code defining a data set storage object based on said selection into a second HTML document, said data set storage object configured to extract said at least some of said content from said container from said first HTML file and to store said extracted content when said data set storage object is instantiated; and
insert a structure into said second HTML document, the structure configured to cause said content to be arranged according to said structure when said second HTML document is rendered.

2. (canceled)

3. The system of claim 1 wherein said data set storage object makes said extracted content available for use within said second HTML document when said second HTML document is rendered.

4. (canceled)

5. The system of claim 1 wherein said content is arranged in a first format in said first HTML document, and said structure is configured to arrange said extracted content in a second format, different from said first format, in said second HTML document.

6. A computer program product having a non-transitory computer readable medium having computer program logic recorded thereon, said computer program product defining an application development environment, the application development environment comprising:
code, when executed by a computer, for selecting a source HTML document, said source HTML document comprising a container comprising content;
code, when executed by a computer, for receiving a selection of said container;
code, when executed by a computer, for automatically creating and embedding program code defining a data set object based on said selection into a World Wide Web application, said data set object configured to extract said at least some of said content from said container from within said source HTML document and to store said extracted content when said data set object is instantiated;
code, when executed by a computer, for specifying a format for said content from said extracted container; and
code, when executed by a computer, for inserting a structure into said World Wide Web application, the structure configured to cause said content to be arranged according to said structure when said World Wide Web application is executed.

7. The computer program product of claim 6 further comprising:
code, when executed by a computer, for publishing said World Wide Web application to a web server.

8. The computer program product of claim 6, wherein said data set object comprises a script-based object with at least one selector for parsing said source HTML document to extract said container.

9. The computer program product of claim 6 wherein said source HTML document and said World Wide Web application comprise the same document.

10. A method comprising:
selecting a source HTML file comprising a container comprising content, said content having a first format;
identifying said container to be extracted from said source HTML file;
automatically creating, within a World Wide Web application, program code defining a data set object based on said identified container, said data set object configured to extract said content from said identified container and to store said extracted content when said data set object is instantiated; and
inserting a structure into said World Wide Web application, said structure configured to arrange said extracted content in a second format when said World Wide Web application is rendered.

11. The method of claim 10 wherein said first format is different from said second format.

12. The method of claim 10 further comprising:
creating a template in said first World Wide Web application, said template including HTML code for arranging said content from said extracted container into a third format.

13. The method of claim 10 further comprising parsing said source HTML file for identifying semantics associated with said container.

14. The method of claim 10 wherein said data set object comprises:
a script-based object, that when instantiated, sends requests to a server for said content from said extracted container from said source HTML file.

15. The method of claim 10 further comprising:
presenting a code view of said first application file; and
presenting a rendered view of said first application file on said computer monitor.

16. The method of claim 10 wherein identifying said container comprises:
presenting a wizard interface to receive user input; and
identifying said container to be extracted based, at least in part, on said received user input.

17. (canceled)

18. The method of claim 10 further comprising:
publishing said source HTML file and said World Wide Web application to a World Wide Web (web) server.

19. The method of claim 10 further comprising:
selecting a display layout for said extracted content when said extracted content is inserted into said World Wide Web application.

20. The method of claim 10 wherein said World Wide Web application comprises said source HTML file.

21. (canceled)

22. (canceled)

23. The system of claim 1, wherein the application development environment is further configured to cause the processor to:
render at least a portion of said first HTML file, said portion comprising said container, and
to receive said selection of said container from within said rendered portion of said first HTML file.

24. The computer program product of claim 6, further comprising:
code, when executed by a computer, for rendering at least a portion of said first HTML file, said portion comprising said container; and
wherein said code, when executed by a computer, for receiving said selection of said container comprises code for receiving said selection from said rendered portion of said first HTML file.

25. The method of claim 10, further comprising:
rendering at least a portion of said source HTML file, said portion comprising said container; and
wherein identifying said container comprises identifying said container from within said rendered portion of said source HTML file.
